(19) United States
(12) Patent Application Publication
(10) Pub. No.: US 2013/0291100 A1
(43) Pub. Date: Oct. 31, 2013

(54) Detection And Prevention Of Machine-To-Machine Hijacking Attacks

(71) Applicants: Sundaram S. Ganapathy, Hillsborough, NJ (US); Ioannis Broustis, Millburn, NJ (US)

(72) Inventors: Sundaram S. Ganapathy, Hillsborough, NJ (US); Ioannis Broustis, Millburn, NJ (US)

(21) Appl. No.: 13/459,402

(22) Filed: Apr. 30, 2012

(51) Int. Cl. G06F 21/00

(52) U.S. Cl. 726/22

(57) ABSTRACT

An example method includes receiving at a network node a packet destined for an intended destination. The network node determines whether the packet is associated with a machine-to-machine communication. The network node determines whether forwarding of the packet to the intended destination is prohibited, wherein forwarding of the packet is prohibited when the packet is originated from a first machine-to-machine device and is destined to a first host other than a machine-to-machine server associated with machine-to-machine communications. The network node forwards the packet to the intended destination when forwarding the packet is not prohibited.

### FIELD OF THE INVENTION

The subject matter of this application relates to machine-to-machine communications and, more specifically but not exclusively to the equipment that detects and prevents machine to machine hijacking attacks.

### BACKGROUND INFORMATION

This section introduces aspects that may help facilitate a better understanding of the disclosed subject matter. Accordingly, the statements of this section are to be read in this light and are not to be understood as admissions about what is in the prior art or what is not in the prior art.

Recently there has been an increase in commercial interest in the potential for vast deployments of infrastructure based machine-type communication (MTC) networks also known as M2M networks. Machine-to-machine (M2M) communications are becoming increasingly popular in the context of cellular networks, due to their unlimited application potentials and the low cost of deployment. For example, many MTC networks are expected to reuse the cellular network infrastructure of mobile network operators, and facilitate a plurality of applications such as smart metering, health monitoring, sensor-based applications and vehicular communications.

It has been projected that the number of cellular M2M devices will range close to three-hundred million (300M) by 2015. It is also estimated that within the following decades, three (3) to four (4) M2M devices will be associated with one or more cellular networks on behalf of each individual person. This implies that 3G and 4G networks will be responsible for managing and maintaining an approximate total of twelve to fifteen billion (12-15B) cheap (i.e., low cost) devices, which will be designed to perform a limited set of predefined tasks; the main task of such M2M devices will involve sporadic, infrequent data exchange only with specific M2M application servers, potentially residing anywhere in the Internet.

The rise in popularity and market inflexion points that have created commoditization of M2M devices, makes these devices attractive for adversarial attacks. Since such devices are typically low cost and designed to perform a set of very specific tasks, attackers can easily abuse an M2M device. For example, attackers may spoof the M2M device's identity and credentials in order to hijack and misuse legitimate data sessions. For instance, hackers may steal the identity of a water meter connected to a cellular network and implant the stolen identity into a laptop and then browse the web. As an example, if sufficient counter measures are not in place, hackers may be simply “insert” a Subscriber Identity Module (SIM) card from a water meter onto a smart phone to gain access to a network. Indeed, devices with very limited processing and storage capabilities can be utilized to trigger clever hijacking attacks.

Given the expected tremendous growth of the M2M market in future years, such attacks would in-turn have a devastating impact on the economics of offering broadband services. It should be noted that even allowing for up to four (4) M2M subscriptions for every user subscription, the revenue associated with all M2M services across all M2M devices will be dwarfed by user subscriptions and services given the expected specific nature of each M2M device. Consequently, the economics of offering broadband services (for both network operators and virtual network operators alike) could be completely destroyed if low cost devices can be hacked to steal broadband services.

### SUMMARY

The following presents a simplified summary of the disclosed subject matter in order to provide an understanding of some aspects of the disclosed subject matter. This summary is not an exhaustive overview of the disclosed subject matter and is not intended to identify key or critical elements of the disclosed subject matter nor delineate the scope of the disclosed subject matter. Its sole purpose is to present some concepts in a simplified form as a prelude to the more detailed description that is discussed later.

Example embodiments for detecting and preventing fraud and network bandwidth stealing, such as M2M device hijacking (e.g., identity spoofing attacks), that are provided herein consider the properties of cellular M2M deployments which make them open to the potential for abuse. These properties include, for example, the limited set of tasks assigned to each device, the ease of device accessibility by attackers and the ability to hack into the low cost hardware/software of M2M devices. Embodiments provided herein may: (a) be network centric; that is; the detection and prevention operations are located at the network backhaul rather than executed by neighbor client devices; and/or (b) avoid the use of processing overhead intensive cryptographic functions. According to various example embodiments provided, M2M client devices are allowed to establish transport sessions only with their affiliated M2M servers. As such, attackers/hackers would not be able to use M2M device credentials in order to freely establish traffic sessions with arbitrary remote hosts.

In one embodiment, a method comprises receiving at a network node a packet destined for an intended destination; determining by the network node whether the packet is associated with a machine-to-machine communication; determining by the network node whether forwarding of the packet to the intended destination is prohibited, wherein forwarding of the packet is prohibited when the packet is originated from a first machine-to-machine device and is destined to a first host other than a machine-to-machine server associated with machine-to-machine communications; and forwarding by the network node the packet to the intended destination when forwarding the packet is not prohibited.

In one embodiment, forwarding of the packet is further prohibited when the packet is originated from a second host other than a machine-to-machine server associated with machine-to-machine communications and is destined to a second machine-to-machine device.

In one embodiment, the determining whether the packet is associated with a machine-to-machine communication includes querying a first memory based on a source address or a destination address of the packet. In one embodiment, an entry of the first memory includes a first field identifying an address of a machine-to-machine device associated with an access network and a second field identifying an address of a M2M server that is associated with the machine-to-machine device. In one embodiment, the entry of the first memory also includes fields identifying one or more of a Network Access Identifier (NAI) of the machine-to-machine device, a Generic Routing Encapsulation (GRE) key corresponding to the machine-to-machine device, a Tunnel End-point Identifier (TEID) corresponding to a General Packet Radio Service Tunneling Protocol (GTP) tunnel, a International Mobile Subscriber Identity (IMSI), and a machine-to-machine device permanent identifier.

In one embodiment, the network node is a Packet Data Serving Node (PDSN), a Radio Network Controller (RNC), a combination thereof such that the steps of the method are performed jointly by a PSDN and a RNC, a Mobile Networking Gateway, a layer 2 anchor point in a mobile Network, or a Messaging Gateway. In one embodiment, the method further includes determining for the packet a mapping between GRE key and source IP address; and forwarding of the packet is further prohibited when the mapping for the packet is not verified.

In one embodiment, an apparatus comprises a processor and an associated memory device, and the processor is configured to receive a packet destined for an intended destination; determine whether the packet is associated with a machine-to-machine communication; determine whether forwarding of the packet to the intended destination is prohibited, the forwarding of the packet is prohibited when the packet is originated from a first machine-to-machine device and is destined to a first host other than a machine-to-machine server associated with machine-to-machine communications; and forward the packet to the intended destination when forwarding the packet is not prohibited.

In one embodiment, the processor is configured is configured to prohibit forwarding of the packet when the packet is originated from a second host other than a machine-to-machine server associated with machine-to-machine communications and is destined to a second machine-to-machine device. In one embodiment, the processor is configured to perform a query of a first memory storage based on a source address or a destination address of the packet in order to determine whether the packet is associated with a machine-to-machine communication.

In one embodiment, an entry of the first memory storage includes a first field identifying an address of a machine-to-machine device associated with an access network and a second field identifying an address of a M2M server that is associated with the machine-to-machine device. In one embodiment, the entry of the first memory storage further includes fields identifying one or more of a Network Access Identifier (NAI) of the machine-to-machine device, a Generic Routing Encapsulation (GRE) key corresponding to the machine-to-machine device, a Tunnel End-point Identifier (TEID) corresponding to a General Packet Radio Service Tunneling Protocol (GTP) tunnel, a International Mobile Subscriber Identity (IMSI), and a machine-to-machine device permanent identifier.

In one embodiment, the associated memory comprises the first memory storage. The first memory storage may be a look-up table and database and the like. In one embodiment, the processor is configured to receive configuration messages including information for storing in the first memory storage. The apparatus may be a network node, a Packet Data Serving Node (PDSN), a Radio Network Controller (RNC), a combination thereof such that the steps of the method are performed jointly by a PSDN and a RNC, a Mobile Networking Gateway, a layer 2 anchor point in a mobile Network, or a Messaging Gateway. In one embodiment, the processor is configured to determine for the packet a mapping between GRE key and source IP address and to prohibit forwarding of the packet when the mapping for the packet is not verified.

### BRIEF DESCRIPTION OF THE DRAWINGS

Other aspects, features and benefits of various embodiments will become more fully apparent, by way of example, from the following detailed description and the accompanying drawings, in which:

FIG. 1 is an example illustration showing M2M hijacking through re-use of a smart card such as a Universal Integrated Circuit Card (UICC);

FIG. 2 illustrates an example signal flow for the situation where an hacker overhears registration parameters and subsequently uses the overheard registration parameters to establish a data session for alternate purposes;

FIG. 3 illustrates an example signal flow for the situation where an hacker installs a legitimate smart card, such as a UICC, into a different device, and subsequently uses the different device to successfully register to the access network and further establish a data session for alternate purposes;

FIG. 4 is an example look-up table entry for an Machine-to-Machine Equipment (M2ME) according to one embodiment;

FIG. 5 is an example decision engine flow chart for handling incoming packets to a Packet Data Serving Node (PDSN) from an Radio Network Controller (RNC);

FIG. 6 is an example decision engine flow chart for handling packets from a PDSN towards an RNC;

FIG. 7 is an example of a payload structure (datagram format) for packets exchanged between PDSN and RNC when sending a request message asking for the IP address of a M2M application server (e.g., M2MSERV_IP_REQ) and upon receipt of the requested IP address (e.g., M2MSERV_IP_COMPLETE) datagram format;

FIG. 8 is an example of a payload structure (datagram format) for packets exchanged between PDSN and RNC when the PSDN responds to a request for the IP address of a M2M application server (e.g., M2MSERV_IP_RESP);

FIG. 9 illustrates one example of protocol steps for provisioning filtering material from a PDSN to an RNC;

FIG. 10 is an example look-up table entry for an M2ME according to one embodiment; and

FIG. 11 is an example illustration of the application of the attack to M2M operators who provide multiple application services to potentially more than one enterprise.

FIG. 12 depicts a high-level block diagram of a computer suitable for use in an embodiment of the PDSN node or RNC equipment for performing the functions described herein.

### DETAILED DESCRIPTION

Various example embodiments will now be described more fully with reference to the accompanying figures, it being noted that specific structural and functional details disclosed herein are merely representative for purposes of describing example embodiments. Example embodiments may be embodied in many alternate forms and should not be construed as limited to only the embodiments set forth herein.

It will be understood that, although the terms first, second, etc. may be used herein to describe various elements, these elements should not be limited by these terms since such terms are only used to distinguish one element from another. For example, a first element could be termed a second element, and, similarly, a second element could be termed a first element, without departing from the scope of example embodiments. Moreover, a first element and second element may be implemented by a single element able to provide the necessary functionality of separate first and second elements.

As used herein the description, the term “and” is used in both the conjunctive and disjunctive sense and includes any and all combinations of one or more of the associated listed items. It will be further understood that the terms “comprises”, “comprising,”, “includes” and “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

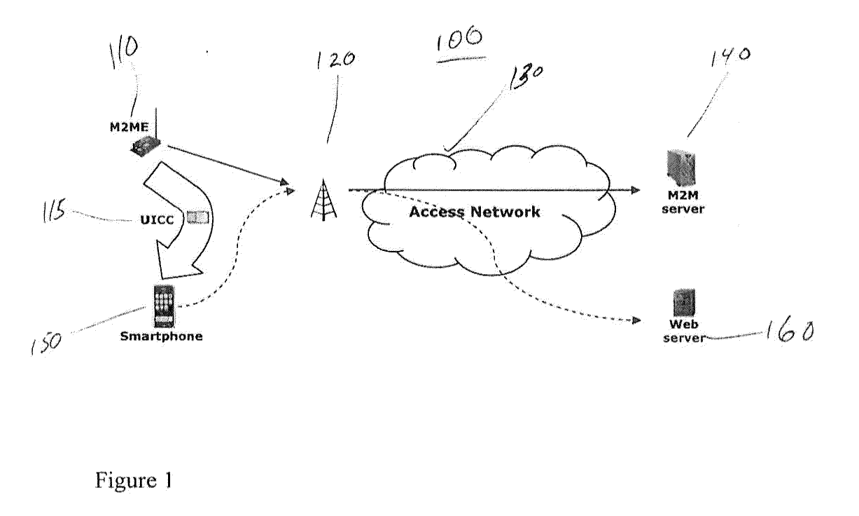

M2M devices are prone to hijacking attacks in which legitimate device credentials are utilized in order to freely access other network services. FIG. 1 is an example illustration showing M2M hijacking through re-use of a smart card such as a Universal Integrated Circuit Card (UICC). In the illustrated M2M network 100, M2M device (i.e., M2M equipment (M2ME)) 110 is provided for communication via radio portion 120 of access network 130 to M2M server 140. Smart card 115 may be removed from the M2ME 110 and installed into another device 150, for example smartphone 150. Although the M2ME was provided for connection to the M2M server (indicated by solid lines), the smartphone may now connect (indicated by dashed lines) to any arbitrary web server 160 using the installed smart card for authenticating to the access network.

In the context of infrastructure cellular networks, at least two properties of M2M devices make these devices prone to hijacking attacks. First, M2M devices typically utilize cheap (i.e., low cost) equipment. In contrast to traditional feature phones and smartphones capable of performing multiple tasks, M2M devices are designed to perform very specific tasks. As an example, a heart monitoring M2M device could simply measure the average number of pulses per minute of a person and send this information to a certain remote server through the attached access network. Such a device would have no further capabilities or tasks. Similarly, a home smart meter M2M device would measure the amount of water that is consumed during a monthly period, and report this information to the water supplier. In both these examples, only a single data session between the M2M device and a predefined server need be established; the M2M device would not need to contact any other entity. Accordingly, the M2M equipment required to perform this limited scope of tasks can have low capabilities and thus naturally can be low in cost (both of manufacture and anticipate use). In fact, the whole notion of M2M becomes attractive to operators (both network operators and virtual network operators) due to the very low cost client equipment that is involved. However, this property also will enable clever adversaries to easily hack into and compromise such devices.

Second, M2M devices typically have associated therewith an ease of accessibility. Envisioned and likely M2M deployments will be comprised mainly of static (or perhaps very low mobility) devices, placed in visible and/or physically accessible locations. As a result, at least two complications arise from a security point of view. First, even adversaries of low-level intelligence will be able to physically access the device and remove/replace the UICC, install sniffers and perform other potential malicious actions. Second, a static device installation directly implies that there are no hand-offs to different base stations or access networks; an attacker will thus be able to easily identify the affiliated access network identity as well as the assigned temporary M2M device identity.

Given these properties, the easiest way of potentially mounting such an attack would be to physically remove the UICC from a mobile device (e.g., a cellphone or an M2M device) and install the UICC into a different device as illustrated in FIG. 1. As an example, consider the scenario where an adversary removes the UICC from an M2M health monitoring device (which may or may not belong to the adversary) and installs it into a smartphone. Given that the UICC is legitimate, the mobile access network will successfully register and authorize access to the smartphone for using the network services. Authorization would be given because all the necessary information for registering a mobile terminal with the access network is located within the UICC. In other words, the access network has no way of explicitly identifying the device that carries the UICC. As a result of this attack, an adversary could use the smartphone to browse the internet at a billing rate that corresponds to the M2M device subscription, and which could be quite minimal in cost or even free, depending on the business/contractual relations between the subscriber, the M2M operator and the network operator.

Along similar lines, in scenarios where the M2M device is not physically accessible, an adversary could possibly overhear the credentials of the M2M device, such as the IP address and the temporary identifier assigned to the device by the access network during registration (e.g., the Unicast Access Terminal Identifier (UATI) for the case of CDMA 1xEV-DO networks). With these overheard credentials, the attacker could potentially manage to inject data packets into the legitimate data session that was setup by the network for the victim M2M device, as discussed further below. Note that while the various security standards for cellular network operations suggest encryption and integrity protection of control signaling as well as encryption of data traffic towards avoiding spoofing and hijacking attacks, these security operations incur tremendous processing overheads (especially on low cost devices). Network operators may even disable these security operations due to these tremendous processing overheads.

Cryptographic operations, such as encryption and/or integrity protection operations, have the potential to clearly address hijacking attacks that depend on spoofing, since the adversary does not possess the encryption keys. However, with certain types of the attack, even encryption and integrity protection are inadequate since the security keys are already stored in the UICC and are thus available to the adversary. Moreover, cryptographic operations are typically prohibitive in terms of processing overhead, especially for low-cost, battery-operated client devices.

Provided herein are example embodiments for detecting and preventing fraud and network bandwidth stealing, such as M2M device hijacking (e.g., identity spoofing attacks). Embodiments provided may be one or more of: (a) network centric; (b) lightweight; and (c) not dependent on the use of UICC. Due to the ease of malicious manipulation of M2M devices, it is very difficult (if not impossible) for any mitigation scheme to rely on the M2M devices themselves while keeping their equipment cost at low levels. Therefore, provided embodiments may be located in the network rather than executed solely or partially by client devices. With such operations, the network is capable of determining whether an M2M device has been compromised, based on the properties of data traffic that flows through the network and involves the device.

The limited hardware and software capabilities of M2M devices in conjunction with the high density of deployment (e.g., the balance of device cost and ubiquity) prohibit the use of cryptographic operations that would provide identity protection, integrity and encryption of data. Thus, certain provided embodiments may not and other provided embodiments do not depend on such cryptographic operations but are lightweight, leveraging simple traffic monitoring techniques at the network side to cope with hijacking attacks. Other provided embodiments are not dependent on the use of UICC. As explained above, the capabilities of a hijacker are enhanced by the presence of a removable security module at the M2M devices; a conventional network identifies the device by verifying the credentials stored in the UICC and thus, any device carrying a legitimate UICC will be granted access to services. In contrast, embodiments provided herein can efficiently mitigate an attack even in the presence of UICC modules, since traffic forwarding decisions are made based on network database queries, which include additional information (available upon successful registration) than that stored in a UICC.

The description of M2M communications is directed toward wide-area M2M, where deployments span a large geographical area and thus, the communication of application servers with client M2M devices is based on a wide area network such as a cellular network. Note however that a generic definition of M2M involves communications to/from devices which are not directly employed by humans. Such communication may occur over any one of a variety of communication networks. Examples of M2 devices include smart meters, health monitoring devices, sensor nodes, location tags, traffic cameras and vending machines, all having networking capabilities. As an example of such functionality, an M2M health monitoring device is expected to capture the condition of one or more vital organs of a human body, and subsequently send the measurements to a remote M2M server (potentially located in an affiliated medical facility—see FIG. 1), through an attached cellular network infrastructure. This task may be performed in a totally seamless manner, without any interventions from the actual patient, and after the device has been successfully registered to receive the offered services. Other M2M devices that communicate information without the intervention of a human subscriber will be readily recognized by one skilled in the art. Various standardization bodies such as the European Telecommunications Standards Institute (ETSI) and the 3rd Generation Partnership Project (3GPP) are already in the process of standardizing the network architecture and the communication protocols that facilitate such services.

Existing countermeasures for providing detection and prevention in the context of the security problems associated with session hijacking are not efficiently applicable in the context of M2M. For example:

Encryption and integrity protection: Cryptographic operations have been proposed for detecting and preventing hijacking attacks. In such systems, the integrity of the control and data messages is protected by: (a) hashing the packet contents using a secret key known only to the participants of the session, and (b) appending the result of the hash operation at the end of the message that is sent. The recipient of the message can then use either the same or a different appropriate secret key to produce the hash result, and compare it against the hash result that is appended in the received message. If the hash results match, then the recipient is certain about the authenticity of the message. In such a system, hijacking is only possible when the adversary manages to obtain the secret key that is used for signing the messages, thereby impersonating the message sender. In addition to integrity protection, the encryption of control and data traffic ensures that the device identity is also protected from spoofing. However, note that (a) in certain cases the device identity has to be sent in the clear, and (b) such cryptographic operations are extremely overhead intensive. Therefore, some studies as well as standards necessitate that data traffic packets are not integrity protected. In practice through, even integrity protection of control traffic injects tremendous overheads into the radio access network and thus, it is many times permanently disabled by most network operators.

IP address based filtering: Internet Protocol (IP) address based filtering checks the source IP address of packets at intermediate routers along a routing path in order to detect impersonation, reflection and hiding attacks. Such techniques involve checking incoming packets using routing tables and looking up the return path for the source IP address, as well as comparing the IP address that has been allocated to a specific Media Access Control (MAC) address, potentially through Internet Protocol Control Protocol (IPCP) or Dynamic Host Configuration Protocol (DHCP). Such techniques however are inadequate, since: an adversarial device may be located in very close proximity to the victim device; the identity (either temporary or permanent) of the source node can also be easily overheard during the device registration procedure (as demonstrate in the following section; and/or depending on the RAN implementation, it is possible that packets originating from client devices do not include any device identities.

Traffic pattern monitoring and classification: Traffic pattern monitoring and classification mechanisms uses IP address information to detect network anomalies, by observing whether certain client devices have been compromised and as consequence their associated traffic patterns have been recently changed (e.g., new destination hosts are used, and different types of traffic are introduced). Such mechanisms have been mainly proposed for detecting worms. However, such techniques are not so efficient in detecting M2M hijacking attacks: a clever adversary may use a very large dataset of M2M overheard IP addresses and temporary identities, and use them in a random fashion. With this, the traffic monitor/classifier cannot effectively identify any malicious traffic, since it is uniformly distributed across multiple seemingly legitimate source nodes.

Device Registration with an Network and Data Traffic Exchange:

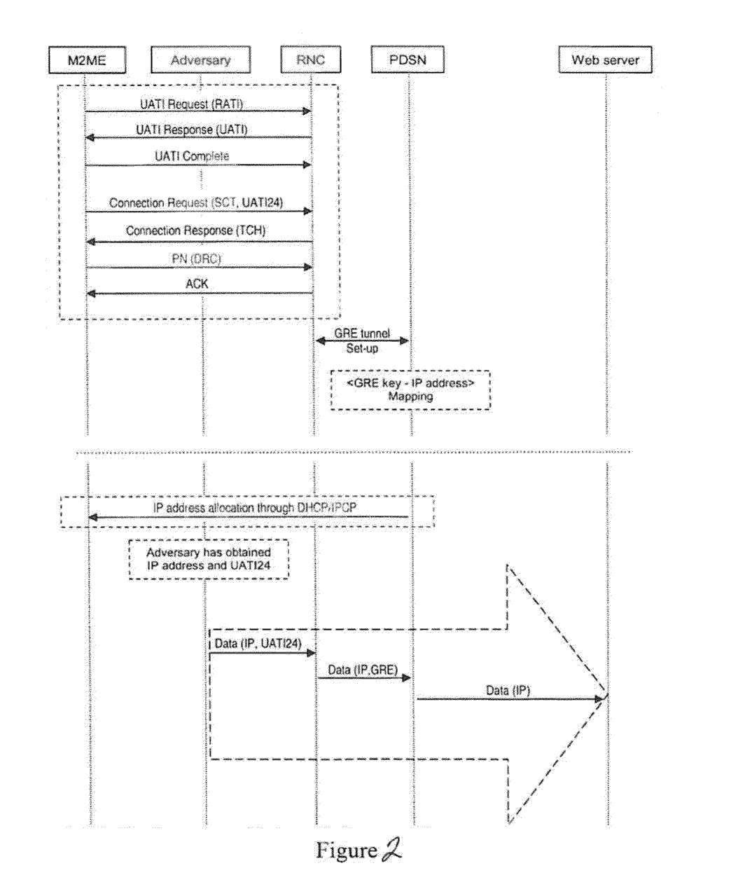

The following details how a data session is established between an M2M device and a remote M2M server. Portions of FIG. 2 illustrate an example signal flow for an M2ME registering with a Radio Network Controller (RNC) and receiving information from a Packet Data Serving Node (PDSN) for the purposes of establishing a data session. The description following is provided in the context of the access network being a High Rate Packet Data (HRPD) based. Nevertheless, the principles detailed are applicable to other network architectures, such as Universal Mobile Telecommunications System (UMTS) and Long Term Evolution (LTE), we are later discussed.

Consider the case where a M2M device (or M2M Equipment (M2ME)) carries a UICC module that is used for registering with an HRPD network. Using the UICC module, M2ME may establish a traffic session with a remote M2M application server (FIG. 1). In order to setup such a session, a variety of events occur including: UATI assignment, connection set-up, GRE tunnel establishment, authentication and data packet handling.

UATI assignment: As shown in FIG. 2, the M2ME first needs to obtain a one-hundred-twenty-eight bit (128-bit) address called UATI (Unicast Access Terminal Identifier). The UATI address includes a color code, which corresponds to the identity of the serving subnet; the color code is represented by the eight (8) most significant bits of the UATI, and is mapped to the one-hundred-four (104) most significant bits of it. In addition, the twenty-four (24) least significant bits (LSB) of the UATI (called UATI24) are used to uniquely identify the M2ME identity within the subnet; this set of bits (i.e., UATI24) is included in control signaling messages sent from the M2ME towards the Radio Network Controller (RNC). The UATI is assigned to the M2ME for the duration of the registration or until the M2ME moves to a new cell-subnet. Hence, at the nominal start of the registration process, the M2ME sends a UATI request message to RNC for allocating a UATI, using the A14 interface. This message contains a Random Access Terminal Identifier (RATI), which is used by RNC to select a UATI for the M2ME. The RNC responds to this request with the allocated UATI. Furthermore, M2ME acknowledges this message with the transmission of a “UATI complete” message to the RNC. Note that at this point M2ME has not registered (and not authenticated) with the access network yet, and thus, the UATI allocation process is not protected in terms of encryption or integrity protection.

Connection set-up: As shown in FIG. 2, the M2ME uses the assigned UATI together with a Session Configuration Token (SCT) in order to establish a traffic connection. For this, M2ME sends a connection request message to RNC, which includes the SCT and UATI24. The RNC acknowledges this request, and further responds with a traffic channel assignment command. This command includes information such as the Walsh cover that is going to be used for the packet preamble related to the certain M2ME, as well as the Walsh cover for DRC (Data Rate Control) messages. Subsequently, M2ME sends a pilot PN and DRC value to RNC, which is followed by the acquisition of the reverse traffic channel for the specific M2ME and the related acknowledgment to M2ME.

Establishment of GRE tunnel: As shown in FIG. 2, the RNC and PDSN establish a Generic Routing Encapsulation (GRE) tunnel which is used for exchanging packets corresponding to the traffic flow(s) of the particular M2ME. For this, an interface, for example the A11 interface, is used to setup a tunnel, for example an A10 tunnel, on which traffic is exchanged. The use of twenty-eight (28) bit GRE keys associated with this tunnel are used by RNC and PDSN to identify the M2ME flows and established sessions; the six (6) LSB of a GRE key correspond to the flow ID, while the twenty (20) LSB are used to identify the session ID. Whenever the M2ME sends a data packet on the uplink traffic channel (the exact packet handling process is described later), the RNC sends this packet to PDSN through the GRE tunnel, using the corresponding GRE key identifier. The PDSN maintains a look-up table for mapping GRE keys to the IP address assigned to a particular M2ME. Packets received through a certain GRE tunnel correspond to a particular IP address, allocated by PDSN (typically through DHCP or IPCP) to M2ME after successful authentication. This look-up table is used by PDSN for incoming packets destined to M2ME: the PDSN queries the look-up table for the destination IP address contained in the packet, in order to determine the GRE tunnel that needs to be used for forwarding the packet towards RNC and further to M2ME.

Authentication: Depending on whether the M2ME is served by the home network (simple IP) or a visited network (mobile IP), different authentication procedures are followed. In either case, the M2ME needs to establish a Point-to-Point Protocol (PPP) session with the PDSN. An interface, for example the A12 interface, is used for the authentication process. For example, CHAP (Challenge Handshake Authentication Protocol) procedures may be utilized in either case (i.e., simple or mobile IP) to validate the credentials that have been provisioned to the UICC that M2ME carries. Upon successful authentication, M2ME can use its assigned IP address to establish end-to-end transport session(s) with one or more M2M application servers; these servers may be residing either within or outside the premises of the HRPD core network operator.

Data packet handling: Given that the above operations are successfully performed, the M2ME can further establish a service layer transport connection with a remote host (potentially an M2M server) in order to exchange data packets. For packet processing steps where the M2ME uploads data to its associated M2M server:

The M2M application at M2ME generates a byte stream, which contains the data that is to be uploaded on the M2M server. This byte stream is fed into a socket towards the IP layer, where IP packets are formed. Assume that the uploaded data can fit into one transport layer packet. Depending on the length of this packet and the network configuration parameters, packet fragmentation may take place thereby splitting the packet into two or more fragments. Each of these fragments is forwarded down to the MAC and Physical (PHY) layers and is subsequently transmitted to the associated base station. For the uplink transmission, the allocated long code is being used by M2ME, which is generated during the registration process using the assigned UATI value.

Then, the base station receives each fragment through the assigned uplink traffic channel and forwards the fragments to the RNC. The latter gathers all fragments and reconstitutes the original IP packet. Furthermore, the RNC identifies the appropriate GRE key and sends the packet to the PDSN via the corresponding GRE tunnel. Note that wireless standards do not define a technique with which the RNC identifies the actual M2ME that sent the fragments; this is left to be decided during implementation, as will be later discussed.

The PDSN then receives the packet and (depending on the implementation) uses its locally maintained look-up table to verify the mapping between the GRE key and assigned IP address. Subsequently, the PDSN routes the packet to its destination using the destination IP address provided by the M2ME.

The reverse process is followed for packets destined to the M2ME. In short, the PDSN consults its look-up table to determine the GRE key that is mapped to the destination address of the packet, and subsequently sends the packet to RNC via the appropriate GRE tunnel. The RNC receives and fragments the packet, and further sends each fragment to the base station. The latter uses the downlink traffic channel to send the fragments to the M2ME. The M2ME receives the fragments, reconstructs the IP packet, strips the IP header off, and finally provides the data payload to the M2M application.

Hijacking:

In what follows, how the above operation can be hijacked by an adversary is explained with focus on two particular forms of such an attack, namely: (a) the spoofing of allocated M2ME identities during and after the registration process, and (b) the physical detachment of the UICC from the M2ME. In addition, the parts of the process are vulnerable to hijacking are discussed, as well as how such vulnerabilities can be overcome.

Attack Version 1: Spoofing M2ME Identity Credentials

In cases where the adversary either cannot physically access the M2ME or does not want to risk tampering with M2ME for the purpose of obtaining identity credentials, it is possible to abuse the access network by hijacking established M2ME traffic sessions. In what follows, the aforementioned steps for registration and packet handling are revisited in order to identify the weak operational points that can be exploited by hijackers. FIG. 2 illustrates an example signal flow for the situation where an hacker overhears registration parameters and subsequently uses the overheard registration parameters to establish a data session for alternate purposes. Accordingly, as shown in FIG. 2, an adversary is interposed between the M2ME and the RNC for overhearing signaling.

UATI assignment and connection set-up: A UATI is a temporary address-identifier that the RNC assigns to the M2ME upon request from the latter. As explained above, the UATI request and response messages are sent in the clear (i.e., they are not encrypted, since there is no security association established at the time of UATI transmission) and hence, the adversary can overhear both messages by sniffing the appropriate uplink and downlink control channels. More than that, the adversary can similarly overhear the traffic session establishment messages, which contain important information such as the Walsh cover and the DRC. As soon as these messages have been overheard, the adversary can generate the following information: (a) the temporary identity of M2ME (e.g., UATI24), the RATI and the SCT, (b) the UATI color code, and (c) the CDMA long code that is used by the M2ME for sending messages to the RAN using the allocated uplink traffic channel (this channel is known to the attacker, since its value is also sent in the clear by the RNC). Note that the adversary can easily detect the CDMA long code that is used for uplink transmissions, since the long code is constructed by a known algorithm, which uses UATI as an input. Since the UATI is known to the adversary through overhearing, deriving the corresponding long code through the execution of the generation algorithm is a rather trivial task.

GRE tunnel set-up and IP address assignment: The RNC and PDSN establish a GRE tunnel for exchanging packets related to M2ME. The GRE key (different for RNC and PDSN) identifies the particular traffic session/flow of the M2ME. For each M2ME, the RNC uses the associated GRE key to tunnel packets to the PDSN. How the RNC determines the identity of the M2ME that sends a packet is not detailed in HRPD related standards documents but such functionality implementation decisions are left for system developers. A commonly followed technique involves including UATI24 into every data packet fragment. In other words, the M2ME includes the UATI24 value into each fragment transmitted on the uplink data traffic channel. Since the RNC is the entity that assigns the UATI to the M2ME during registration, the RNC is aware of UATI24. Whenever a new data fragment is received, the RNC derives the UATI24 from the fragment header thereby identifying the origin of the fragment. With this, the RNC can subsequently reconstruct the packet by merging the individual fragments and further tunnelling the packet to the PDSN. An alternative implementation could involve the maintenance of look-up tables of the form <IP address-GRE key> at the RNC site. In such a case, the RNC would identify the appropriate GRE tunnel based on the source IP address of the IP packet after defragmentation. Again, note that different vendors may implement different techniques with which RNC identifies the packet source—M2ME.

Mounting the attack: The goal of the attacker is to use legitimate M2ME credentials in order to freely access network services. As an example, assume that the attacker wishes to establish a UDP connection with a remote host, and stream data (e.g. video traffic) on the uplink direction. Given the above discussion, the adversary would be able to freely use the uplink traffic channel as follows:

The adversary overhears all packet exchanges between the M2ME and RNC during registration. Recall that all these messages are not encrypted. Hence, the UATI and the IP address are obtained by the adversary through passive overhearing.

The application layer at the adversarial client device generates video frames (e.g., through a webcam application). Each such frame is forwarded down to the IP layer, where it is encapsulated into an IP layer packet. The IP encapsulation function has been modified by the attacker to include: (a) the overheard IP address as the IP source, and (b) the IP address of the attacker's desired remote host, as the IP destination.

Every fragment is forwarded to the MAC layer, where a MAC header is added; this header includes the overheard UATI24 value. The PHY layer transmits every MAC frame to the base station using the long code that corresponds to the assigned UATI; since the UATI is known to the attacker, the latter is able to reconstruct the long code corresponding to the overheard UATI. For each fragment transmission, the uplink traffic channel that was allocated to the M2ME by the RNC during connection set-up is used.

The base station forwards each fragment to the RNC, which merges fragments in order to reconstruct the IP layer packet. As per typical RNC implementations, the RNC checks the MAC header of each fragment in order to identify the originating M2ME, through the UATI24 value. This value is then used for querying the locally maintained <UATI24-GRE Key> in order to tunnel the IP packet to the PDSN, using for example, the A10 interface. Note that RNC receives fragments containing a legitimate UATI value and thus, the RNC is left to “believe” that the fragments were sent by the device that initially requested the specific UATI assignment.

As shown in FIG. 2, an adversary overhears registration session parameters that are exchanged in the clear between the M2ME and access network. Subsequently, after the adversary has obtained the IP address and UATI24, the adversary may utilize these parameters to establish data sessions with remote servers.

When the PDSN receives the IP packet from the GRE tunnel, it consults its locally maintained look-up table to verify that the source IP address actually corresponds to the GRE key used. As long as the entry is verified, the packet is routed to the adversary's intended destination. For this, the destination IP address of the packet is utilized. Clearly, the PDSN has no further reason to challenge the validity of this packet; the source IP is a legitimate address that was allocated to M2ME during registration, and corresponds to the matching GRE key.

Assuming that the adversary can always overhear signaling messages-commands from the RAN towards the abused M2ME, the adversary can always respond to such commands using either its own credentials or the overheard ones. Clearly, the adversary need not be always located next to M2ME, but alternatively may be close to the base station.

From this description, it is evident that the adversary simply needs to overhear the UATI and the IP addresses that are assigned to M2ME by the access network operator. Using these values, the attacker can generate packet headers which “mislead” the access network into believing that the packets are originating from a legitimate client.

Note that the adversary needs to use both the specific overheard UATI and IP addresses (assigned to the same legitimate M2ME). Only one of these values is not sufficient, since if a different UATI is utilized, it will correspond to a different long code and a different GRE key. Assuming that this UATI actually exists, it will lead RNC into using a different GRE tunnel. The PDSN will then reject the packet, since there will be no match between the used IP address and the GRE key. Furthermore, if a different (non-overheard) IP address is used, the packet will be rejected by PDSN for the exact same reason: the PDSN will not identify any valid <GRE key-IP address> tuples in its locally stored look-up table. Therefore, both UATI and IP address (assigned to the same M2ME) need to be overheard in order for the attack to be successful.

Attack Version 2: Physically Removing the UICC from M2ME

As discussed above, it is contemplated that a plurality of M2M devices will be permanently placed at easily accessible locations, potentially outdoors. Such a type of mass deployment may enable an adversary to physically access an unattended M2ME in order to steal the device credentials. For example, in the case of a 3GPP M2ME, an adversary could physically remove the installed UICC. The stolen UICC could further be installed into a compatible smartphone (see FIG. 1). Such an attack allows the adversary to freely use the access network services (allocated for M2M traffic) potentially for completely irrelevant purposes, e.g. for browsing the Internet.

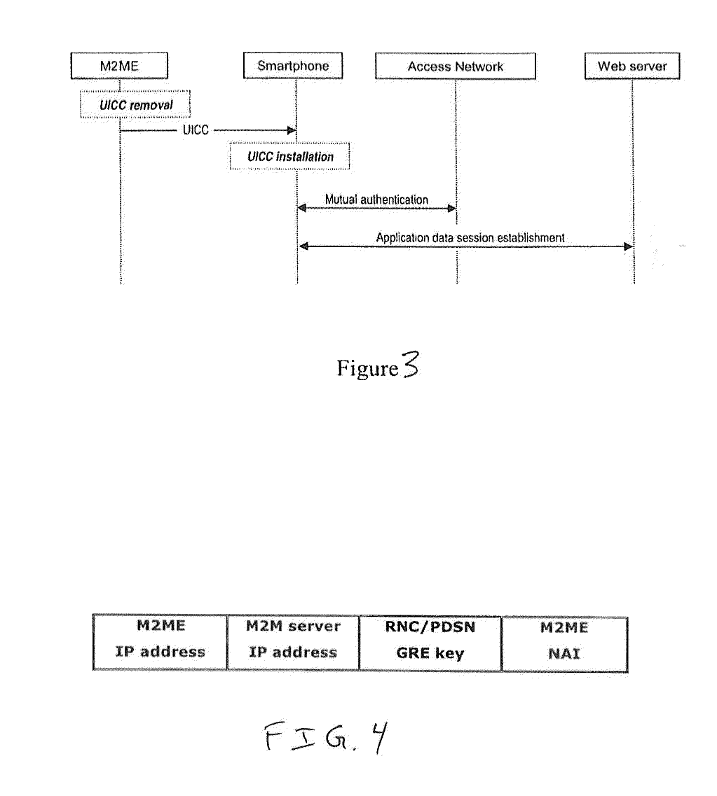

More specifically, with respect to FIG. 3 which illustrates an example signal flow for the situation where an hacker installs a legitimate smart card, such as a UICC, into a different device, and subsequently uses the different device to successfully register to the access network and further establish a data session for alternate purposes, the physical removal and use of UICC suffers form the following effects (assuming that a UICC for M2ME does not differ from UICC for UE in terms of authentication operations):
the access network authentication procedure discussed above will verify the credentials contained in the UICC. Hence, irrespective of the device that is hosting the UICC, the registration process will verify the UICC validity and successfully authorize the device into using the network services (as per FIG. 3) to further establish data sessions with arbitrary remote servers. Note that this problem exists with any ordinary mobile device that carries a UICC; i.e., it is not specific to M2ME.
all temporary identity credentials and associated network configuration parameters (such as UATI, long code, GRE key, IP address, PDSN look-up table, etc.) will be generated for the adversary device that carries the legitimate UICC (e.g., the adversary's smartphone device). In other words, currently the access network has no way of differentiating a smartphone from an M2ME. As long as the adversary device carries a legitimate UICC, that device will be granted access to network services.
the adversary may need not to attempt to physically access a M2ME belonging to someone else; the adversary may own/control the abused M2ME/UICC. For example, an adversary could detach the UICC from his/her health monitoring device and install it into a smartphone. An incentive for such an action could be that the access network operator billing rates corresponding to M2M operations are much smaller than for regular 3G data connectivity. In addition, since M2M devices are not expected to send high volumes of traffic (in fact they may be sending only one or more measurement-related messages per month), affiliated M2M servers will likely have difficulty detecting abused.
assuming that the RAN and core network implementations do not include techniques beyond the ones specified in the related standards documents, the use of a foreign, legitimate M2M UICC can clearly go undetected even if the access network provider has activated encryption and integrity protection operations. This is because the keys used for encryption and integrity protection are renewed at every new registration. Hence, the adversarial device will be able to generate such keys, since it carries a legitimate UICC. Packets originated from this device will be normally encrypted and potentially integrity protected using those keys.

Thus, it is evident that currently the access network will authorize access to any device carrying a legitimate, regular UICC. In other words, the access network has no way of detecting this type of hijacking attack.

Mitigating Hijacking:

In the following, a methodology/mechanism is presented with which the access network can mitigate this M2M hijacking attack. While the proposed functionality is described for HRPD access networks, the solution is applicable to other access technologies, such as UMTS and LTE.

As discussed earlier, an M2ME typically will be assigned a very specific set of tasks, such as periodically communicating gas meter measurements to a remote M2M application server. Hence, in most cases, there is no legitimate reason for an M2ME to establish connections with remote hosts other than the associated M2M server. In other words, the network should prohibit forwarding M2ME-originated packets destined to hosts other than the associated M2M server(s). Similarly, the network should not forward packets towards M2MEs, if such packets originate from non-related M2M hosts. Therefore, the access network should be capable of detecting such actions and filter out those packets. On the other hand, the access network should allow other legitimate client devices, such as smartphones, to establish connections with any intended host. Such a capability necessitates that the access network can distinguish M2MEs from other types of client devices, and is aware of the M2M servers that the M2MEs are associated with. Note that certain M2M applications may require that an M2ME actually connects to multiple non-related M2M hosts in the Web in order to perform its tasks. In other words, it may not be sufficient for the M2M application to send/receive packets only with M2M server(s), but the M2M application may also be required to communicate with other hosts residing in arbitrary locations in the Web. In such cases, the M2M device should still establish a connection with its affiliated M2M application server. The latter should then play the role of an Internet proxy, which decides if M2ME-originated packets are to be further forwarded to/from other Internet hosts.

Based on these requirements, the embodiments of the proposed solution involve the construction and maintenance of a new look-up table, residing at the access network. FIG. 4 is an example look-up table entry for an Machine-to-Machine Equipment (M2ME) according to one embodiment. Such a table can be formed using information that is already available to the access network. In particular, for any given M2ME the information that may be included in the look-up table includes:
the IP address of the device. Assuming that an M2ME is uploading data to a server, the source IP address in each packet should belong to a legitimate M2ME, associated with the access network.
the IP address of the M2M server that is associated with each M2ME. The network should know that an M2ME is supposed to contact a particular M2M server (or list of servers).
the Network Access Identifier (NAI) of the M2ME. This information is typically pre-provisioned into M2MEs prior to initial registration, and is also provisioned to the AAA servers (at RAN and core parts of the network) that verify the authenticity of M2ME.
the GRE key corresponding to the M2ME: This key is different for RNC and PDSN, and is established during M2ME registration.

The hijacking mitigation functionality is based on packet filtering, and can be performed either by the PDSN or by the RNC. In the case of packet filtering performed by the PDSN, assume that this look-up table of FIG. 4 is stored at the PDSN site. In that case, the stored look-up table is an enhanced version of the <GRE key-IP address> lookup table that is already conventionally stored at the PDSN.

PDSN Filtering on the Uplink Direction

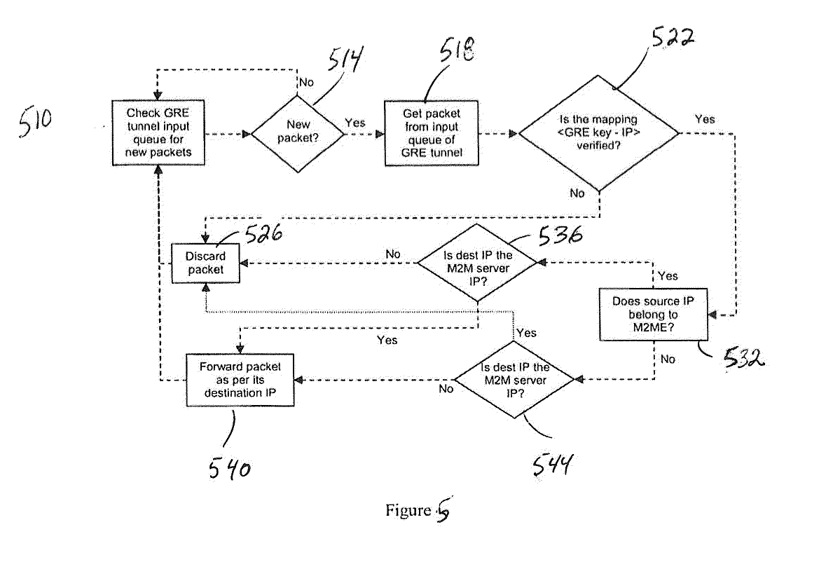

FIG. 5 is an example decision engine flow chart for handling incoming packets to a Packet Data Serving Node (PDSN) from a Radio Network Controller (RNC). As per the proposed hijacking mitigation methodology, for every packet that arrives at the PDSN from the GRE tunnel, the PDSN now may perform filtering operations.

At step 510, the GRE tunnel input queue is checked for new packets. At step 514, it is determined whether a new packet has arrived at the GRE tunnel input queue. If no new packet has arrived, the method loops to step 510 to again check for new packets. If a new packet has arrived, at step 518, the new packet is obtained from the queue of the GRE tunnel.

At step 522, the mapping between GRE key and source IP address is verified. This operation is performed by the PDSN, as per the above description. If such a mapping is not identified in the locally maintained look-up table, at step 526, the PDSN should drop the packet without forwarding it further.

If a mapping is identified in the look-up table (step 522), at step 532, it is determined whether the source IP in the received packet belongs to a M2ME or to a regular client device. For this, the Network Access Identifier (NAI) that corresponds to the source IP address is determined. The NAI can be provided to the PDSN during M2ME authentication, since it is contained in the Challenge Handshake Authentication Protocol (CHAP) response message from M2ME, after the Point-to-Point Protocol (PPPO and Link Control Protocol (LCP) negotiation process.

Based on whether the packet was sent by M2ME or by a different type of device (step 532), the PDSN should follow one of the following steps. If the source IP address belongs to an M2ME, at step 536 it is determined whether the destination IP address corresponds to an associated M2M server. Such a client-server association may be pre-provisioned to the access network—potentially into the Authentication, Authorization and Accounting (AAA) server that contains the entry of the particular M2ME. If PDSN detects that the M2ME-originated packet is not destined to its associated M2M server(s), the packet is discarded at step 526. If the PDSN detects that the M2ME-originated packet is destined to its associated M2M server(s), at step 540 the packet is forwarded as per its destination IP address.

If the source IP address does not correspond to an M2ME (step 532), at step 544, it is determined whether the packet is destined to an M2M server, by checking the destination IP address. If the packet is destined to an M2M server, then at step 526 the packet is simply discarded. Such a scenario may indicate the possibility of a hijacking-based flooding attack, in an attempt to overflow the M2M server or the intermediate routers along the path to the M2M server. If the packet is not destined to an M2M server, at step 540 the packet is forwarded as per its destination IP address.

PDSN Filtering on the Downlink Direction

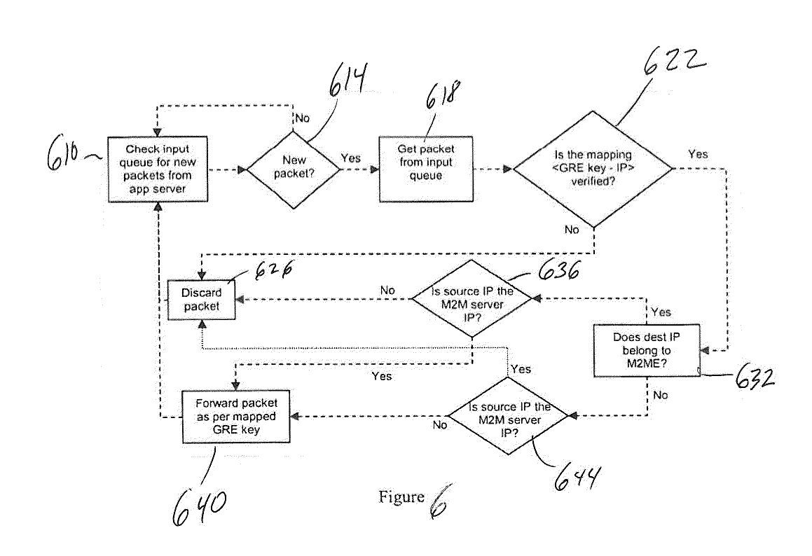

In a similar manner, PDSN may handle packets destined to client devices of the access network. FIG. 6 is an example decision engine flow chart for handling packets from a PDSN towards an RNC.

At step 610, the GRE tunnel input queue is checked for new packets. At step 514, it is determined whether a new packet has arrived at the GRE tunnel input queue. If no new packet has arrived, the method loops to step 610 to again check for new packets. If a new packet has arrived, at step 618, the new packet is obtained from the queue of the GRE tunnel.

At step 622, the mapping between GRE key and source IP address is verified. This operation is performed by the PDSN, as per the above description. If such a mapping is not identified in the locally maintained look-up table, at step 626, the PDSN should drop the packet without forwarding it further.

If a mapping is identified in the look-up table (step 622), at step 632, it is determined whether the destination IP in the received packet belongs to a M2ME or to a regular client device. For this, the Network Access Identifier (NAI) that corresponds to the destination IP address is determined.

Based on whether the packet is destined for a M2ME or a different type of device (step 632), the PDSN should follow one of the following steps. If the destination IP address belongs to an M2ME, at step 636 it is determined whether the source IP address corresponds to an associated M2M server. If PDSN detects that the packet is not originated from any affiliated M2M servers, the packet should be discarded at step 626. If the PDSN detects that the packet is originated from an affiliated M2M server, at step 640 the packet is forwarded as per its destination IP address.

If the destination IP address does not correspond to an M2ME (step 632), at step 644, it is determined whether the packet is originated from an M2M server, by checking the source IP address. If the packet is indeed originated from an M2M server, then at step 626 the PDSN should discard the packet, since there is a possibility that the M2M server has been compromised. If the packet is not originated from an M2M server, at step 640 the packet is forwarded as per its destination IP address.

Note that all the above cases can be simple entries in the PDSN firewall. These entries can be individually enabled or disabled at any time, based on network operator preferences. Note also that these are post-registration operations, i.e., these filters will be enabled after the M2ME has been successfully registered with the access network.

In order to perform these filtering operations, the PDSN needs to be aware of the following four parameters: (a) the IP address that is allocated to M2ME, (b) the corresponding GRE key, (c) the NAI of that M2ME, and (d) the IP address of the M2M server with which M2ME is associated. The PDSN is already aware of parameters (a), (b) and (c), as explained in the above. Furthermore, for every M2ME, parameter (d) may be a priori provisioned into the AAA server (the method of such a provisioning is known to those skilled in the art of the invention). The PDSN may receive this additional parameter during M2ME registration. In particular, if the AAA successfully verifies the authenticity of M2ME during registration, a success message will be returned to PDSN; parameter (d) can be included into that success message, or sent via a separate message. With this, the PDSN will have all required parameters in order to construct the look-up table that will be used for the filtering.

RNC Packet Filtering

Embodiment of the proposed invention may alternatively be applied by an RNC site. An incentive for such a decision would be twofold. First, part of the filtering operation is offloaded to the RNC and as a result, the PDSN is not overloaded in terms of processing. This is expected to be very helpful in large-scale M2M deployments, where a single PDSN will be responsible for routing traffic from/to many millions of M2M devices, in addition to the load due to regular data users. Second, filtering operations at the RNC will be capable of early detecting uplink flooding attacks, well before malicious packets travel through a potentially long path before reaching the PDSN. In order for the security solution to be potent, the RNC should be able to perform packet filtering in a similar manner, as described above. While the RNC is already aware of the GRE key (as well as the NAI) for a specific M2ME, other required parameter values are currently unknown.

There are a variety of methods by which the RNC may perform the required traffic filtering functionality. In a first approach, the PDSN provides the IP address of the corresponding M2M server to the RNC. Such a delivery can be performed either through a simple request/response message exchange protocol between the RNC and the PDSN, or by appending this information into the IP address assignment response message, which is sent from the PDSN to the M2ME.

The following protocol for provisioning information from the PDSN to the RNC may be followed in order for RNC to receive the necessary filtering data.

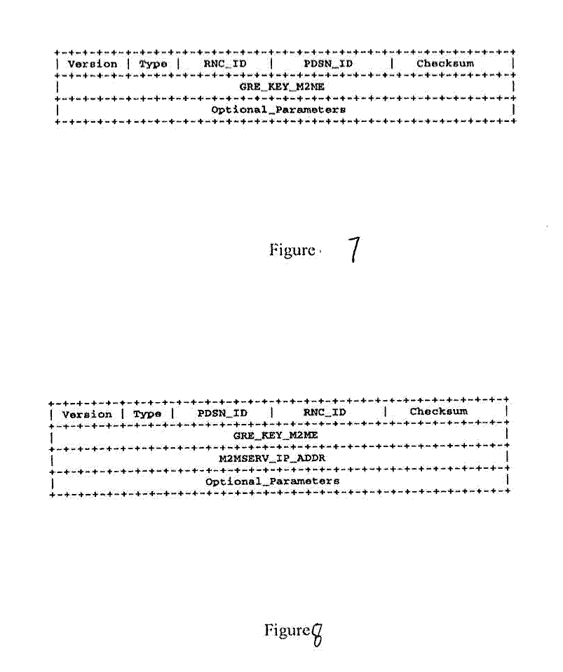

1) The RNC sends a request message to PDSN (e.g., M2MSERV_IP_REQ), asking for the IP address of the M2M application server. For this, the corresponding GRE keys (at RNC and PDSN) are used for identifying the M2ME of interest. FIG. 7 is an example of a payload structure (datagram format) for packets exchanged between PDSN and RNC when sending a request message asking for the IP address of a M2M application server (e.g., M2MSERV_IP_REQ) and upon receipt of the requested IP address (e.g., M2MSERV_IP_COMPLETE) datagram format. The request message datagram format may be structured as illustrated in FIG. 7 and can be embedded as payload into other potential packets exchanged between PDSN and RNC. The fields that comprise this structure include Version, Type, RNC_ID, PDSN_ID, Checksum, GRE_KEY_M2ME, and other optional parameters. The Version field specifies the protocol version used for this message. The Type field specifies the type of this packet, e.g. “M2MSERV_IP_REQ”, for requesting the M2M application server IP address for the particular M2ME. The RNC_ID field provides the identity of the RNC and is optional. The PDSN_ID field provides the identity of the PDSN and is optional. The checksum field is used to detect data corruption in the message. The GRE_KEY_M2ME field identifies the GRE key for the tunnel associated with the particular M2ME. The Optional_Parameters fields include parameters that may need to be included in this datagram, depending on the exact protocol specification used.

2) The PDSN responds with the IP address of the M2M server, in for example a M2MSERV_IP_RESP message. FIG. 8 illustrates an example of a payload structure (datagram format) for packets exchanged between PDSN and RNC when the PSDN responds to a request for the IP address of a M2M application server (e.g., M2MSERV_IP_RESP). As compare to FIG. 7, the datagram of FIG. 8 has an additional field (M2MSERV_IP_ADDR), which is the requested IP address of the M2M application server associated with the M2ME.

3) After the reception of the response from the PDSN, the RNC sends a M2MSERV_IP_COMPLETE message to PDSN. The datagram template is the same as for the M2MSERV_IP_REQ message (see FIG. 7); potentially only the “Type” field value will be different, to declare that RNC has received the requested IP address.

Note here that: (a) NAI does not need to be sent by PDSN, since it was contained into the CHAP response from M2ME during access authentication and thus, RNC is already aware of it; and (b) The IP address of M2ME is also not needed, since the NAI parameter can be used instead, as explain further below. Finally, as an alternative approach, the PDSN may return the locally maintained look-up table entry for the specific M2ME, in the form of a vector. As one may expect, while this approach significantly simplifies implementation, it projects additional networking overhead.

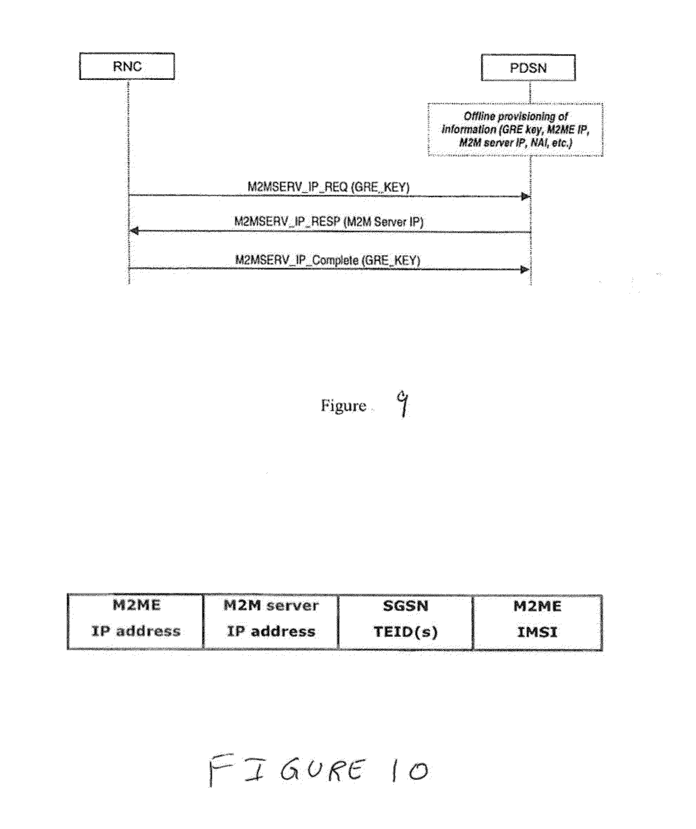

FIG. 9 illustrates one example of protocol steps for provisioning filtering material from a PDSN to an RNC corresponding to the aforementioned protocol. In the case of tapping into the PPP connection between the M2ME and the PDSN, the RNC exploits the IP address assignment message that is sent by the PDSN through the PPP connection established between the PDSN and the M2ME. This message is enhanced with the IP address of the associated M2M server. The RNC monitors the PPP traffic between M2ME and PDSN in order to detect this IP address assignment message. As long as this message is detected, RNC will strip the IP address of the M2M server off and forward the remaining of the message to M2ME. Again here, the NAI parameter is already known to RNC, since it was included in the CHAP response from M2ME during RAN authentication.

At this point, RNC has all the required information to perform traffic filtering. Such filtering could be performed exactly as described earlier; in such a case, the RNC needs to additionally obtain the IP address of M2ME. Alternatively, the RNC can perform filtering by utilizing the NAI parameter of M2ME and the IP address of the M2M server. Recall that the PDSN is already assigned with the task of verifying the mapping between the GRE key and M2ME IP. More specifically, the RNC performs traffic filtering. For uplink traffic, given the NAI/UATI of M2ME, the RNC determines whether the destination IP address (in uplink M2ME packets) corresponds to an associated M2M server. If the RNC detects that the M2ME-originated packet is not destined to its associated M2M server(s), the packet should be discarded. Furthermore, if the UATI does not correspond to an M2ME, the RNC determines whether the packet is destined to an M2M server, by checking the destination IP address. If it does, then RNC simply discards the packet. Again here, such scenarios may indicate the possibility of a flooding attack, or an attempt to overflow the M2M server.

For downlink traffic, for packets destined to M2ME, RNC operates as follows. If the GRE tunnel from which the packet was obtained belongs to an M2ME, the RNC determines whether the source IP address in the packet corresponds to an associated M2M server. If the RNC detects that the packet is not originated from any affiliated M2M servers, the packet should be discarded. In addition, if the packet is not destined to an M2ME, the RNC determines whether the packet is originated from an M2M server, by checking the source IP address. If the packet is indeed originated from an M2M server, then the RNC should discard the packet, since there is a possibility that the M2M server has been compromised.

Recall that all the above filtering cases can be realized as simple entries in the RNC firewall. They can be individually enabled or disabled at any time, based on network operator preferences.

In another embodiment of the proposed invention, a AAA server at the RAN level is provisioned with the filtering information and the RNC receives the IP address of the M2M server from the AAA server that is located in the RAN. For this embodiment, the AAA server will be pre-provisioned with such information (provisioning of the IP address of M2M servers into the AAA server is know to those skilled in the art of the invention). Given that this information is stored in the AAA server, the latter can append this information into the authentication response (success) message that is sent from the AAA to the M2ME during network access authentication, or alternatively send it in a separate message. As soon as the RNC becomes aware of this information, packet filtering can be perform as per the earlier discussion.

Packet Filtering Performed Jointly by PDSN and RNC

In another embodiment, the proposed filtering scheme can be performed jointly by the PDSN and the RNC. Specifically, the RNC can be assigned the task of filtering uplink M2ME traffic, while the PDSN can handle the filtering of ingress traffic. One advantage of such an approach is that flooding attacks can be early blocked. More specifically, the traffic due to a hijacking based flooding attack (where the adversary uses legitimate M2ME credentials with arbitrary destination IP addresses, in order to flood the network with dummy packets) can be blocked at the RNC. Moreover, the traffic due to such attacks that originate from outsider attackers and target legitimate M2MEs can be blocked at the PDSN. Implementing this solution is trivial, given the previous discussion.

However, specifically, the default filtering operations include the RNC discarding packets of the form <M2ME source IP-non-M2M server destination IP> as well as <non-M2ME source IP-M2M server destination IP> and the PDSN filtering out packets of the form: <M2M server source IP-non-M2ME destination IP> as well as <non-M2M server source IP-M2ME destination IP>. While this joint solution will likely increase the cost of application of the filtering scheme (since it requires updates to more pieces of hardware), it is expected to significantly alleviate the effects of hijacking based flooding attacks.

Embodiments with Other Network Technologies

The M2ME hijacking attack can be mounted on M2M settings where the access network technology may vary. Embodiments of the invention can be easily realized in other cellular network technologies with trivial adjustments. For example, while Universal Mobile telecommunication System (UMTS) architecture and traffic session establishment/maintenance differ to some extent from those in HRPD, only minor modifications to the embodiments previously described are required. Such modifications are required only due to the fact that the network architecture and respective protocol operations are different from those in HRPD. In fact the nature of the attack is exactly the same: mounting such an attack projects the exact same requirements as in the case of HRPD, namely either overhearing temporary client identifiers, or using a legitimate UICC module, initially installed into a legitimate M2ME.

The core side of the UMTS network is based on the General Packet Radio Service (GPRS) infrastructure. In particular, SGSN (Serving GPRS Support Node) is responsible for packet data delivery from/to mobile devices (M2MEs in this case) that are located within a specific service area. A GGSN (Gateway GPRS Support Node) is allocated the task of inter-networking between the UMTS network and external packet switched networks. These two network entities mutually construct and maintain a data structure called PDP (Packet Data Protocol) context. This structure is generated upon registration and contains M2ME related information, such as: (a) the IP address that is allocated to M2ME during registration, (b) the IMSI (International Mobile Subscriber Identity), which is pre-provisioned in the UICC card of M2ME, and (c) the Tunnel End-point ID (TEID), which identifies the GTP (GPRS Tunneling Protocol) tunnel associated with a particular PDP context (multiple tunnels may be established, corresponding to different Quality of Service (QoS) requirements). Note that SGSN and GGSN each have a separate TEID, corresponding to a specific M2ME. Important PDP context entries, such the M2ME IP address and IMSI can become known to an adversary through medium overhearing, similarly to the case of HRPD.

In an Ultra Terrestrial Radio Access Network (UTRAN), an important network element is Radio Network Controller (RNC), which performs radio resource management, traffic scheduling, controls the node-Bs and forwards packets to/from M2MEs and the core network. The RNC is the point of connection between UTRAN and the packet core network; it interacts with SGSN through the lu-PS interface. GTP-U (General Packet Radio Service Tunneling Protocol) is used for carrying user packet data between RNC and SGSN; RANAP (Radio Access Network Application Part) is used to establish GTP-U tunnel(s) between SGSN and RNC. RNC receives MAC PDU frames from M2ME through node-B, assembles the frame to IP packets and tunnels the packets to SGSN through GTP-U. Every MAC PDU frame sent over a transport channel (e.g. DTCH) includes a UE-id in the PDU header; the UE-id is used to identify the client device that sent the frame, as well as help RNC in reconstructing IP packets by merging PDUs originated from the same UE (M2ME). This identifier can be obtained by an adversary through overhearing on the appropriate transport channel(s). More than that, M2ME is supposed to send IMSI in the clear, in cases where the access network is not able to identify the device through Temporary Mobile Subscriber Identity (TMSI). Hence, the IMSI can also be overheard by adversaries, by sniffing messages on the appropriate control channel(s). While we discuss these set of network functionalities in high level, the details for these operations are well documented and known to those skilled in the art of the invention.

In the case of UMTS, the M2M hijacking attack can be mounted in a way that is identical to the case of HRPD. As discussed above, an adversary can obtain the IMSI, TMSI, UE-id and IP address of every collocated M2ME, simply by overhearing particular control and data channels. Again, the attack is even simpler if a legitimate UICC from an M2ME is to be used on a smartphone or laptop computer. In the former case, the adversary needs to overhear a legitimate M2ME IP address and the corresponding UE-id, and include them in data frames transmitted in the uplink direction, destined to the intended remote host(s). In the latter case, the use of a UICC belonging to a legitimate M2ME is sufficient: the adversarial device will successfully register with the UMTS network and start using it as a means of transport for sending uplink traffic to intended remote hosts. Hence, the hijacking attack can be applied in the same way as in HRPD.

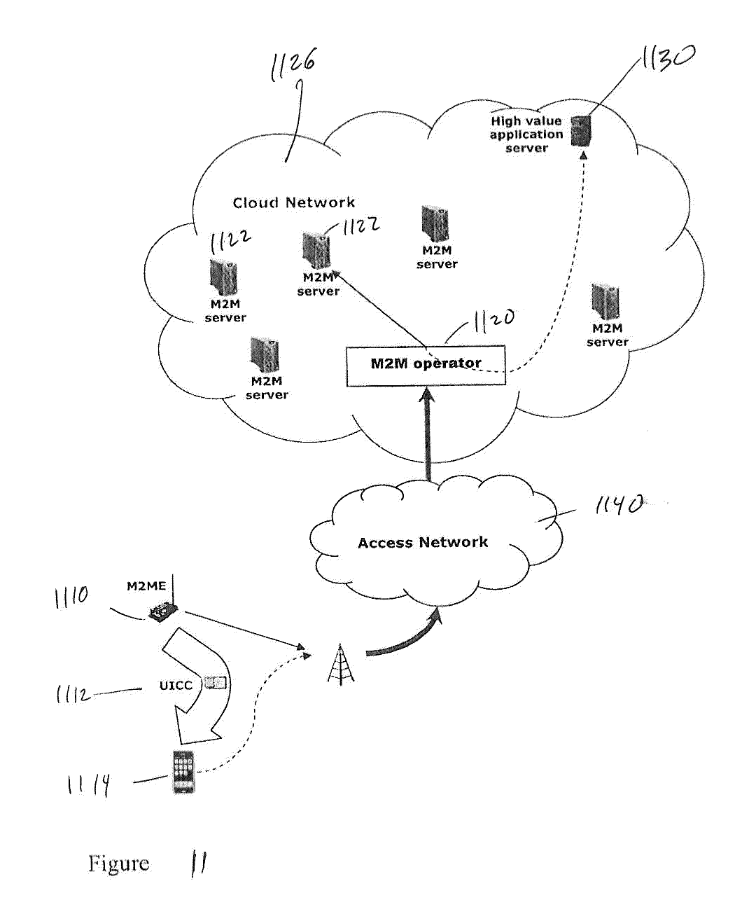

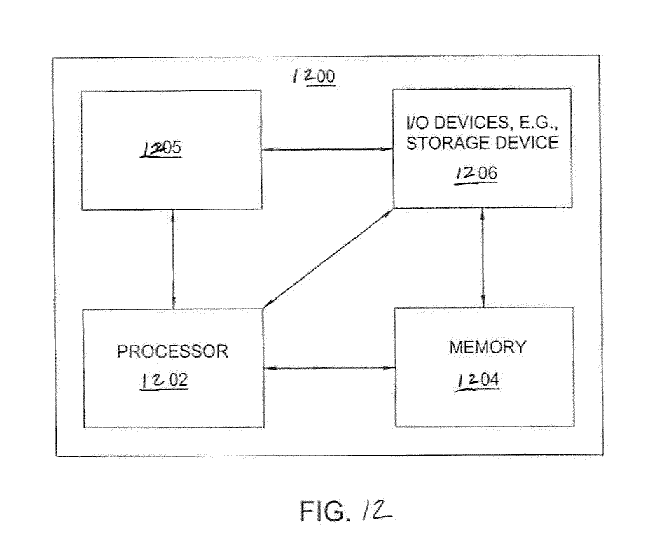

In a UMTS, embodiments of the invention can be applied by enforcing the same set of rules regarding the observed source and destination IP addresses that are embedded in data packet headers. For example, for packet filtering at the SGSN, the locally maintained look-up table at the SGSN location would have the same general structure earlier described with respect to FIG. 4; the M2ME IP address and corresponding M2M server IP address remain the same. Moreover, the GRE key entry of FIG. 4 shall be replaced by a TEID entry, which identifies the corresponding GTP tunnel. Multiple TEID values will have to be included into table entries, corresponding to M2MEs where more than one GTP-U tunnels are established for QoS purposes. (It is unlikely that M2MEs will establish multiple GTP-U tunnels or PDP contexts for QoS purposes; however, this functionality is included for the sake of completeness). Finally, IMSI (or any future standardized M2ME permanent identifier) will be included in the table. Hence, a look-up table entry (when this is locally maintained by SGSN) would look like the FIG. 10

The SGSN may be provisioned with the IP address of the M2M server either through administrative firewall pre-provisioning via one of a variety of method known to one skilled in the art of the invention, or by receiving this IP address from HSS upon M2ME registration, where such information may be appended in the authentication success message from HSS. Alternatively, the SGSN may request such information from HSS using a simple request/response protocol, similar to the one described earlier.

For an embodiment with packet filtering applied at the RNC, the SGSN provides the information for performing the required filtering operations. Specifically, while the IP address of M2ME can be obtained by the RNC through traffic monitoring (e.g. by overhearing the IP address allocation message), the IP address of the corresponding M2M server is not known by the RNC and should be provided by SGSN. Based on this information, the RNC may apply the filtering rules stated earlier.

For an embodiment with joint packet filtering, in a manner analogous to that described earlier, the proposed filtering scheme can be jointly applied by the RNC and the SGSN (or GGSN). Note here that GGSN can be made aware of the required information to perform filtering, in the same way as RNC. Hence, RNC can be assigned the task of filtering out uplink data packets, while GGSN can performing filtering for packets destined towards UTRAN, based on the filtering rules that explained earlier.

In other embodiments, the methodology of the invention may be implemented in a Mobile Networking Gateway such as a SGSN, GGSN, HA, etc, in a layer 2 anchor point in a mobile Network, for example an RNC and the like, or in a Messaging Gateway.

The flat architecture of LTE is equally vulnerable to the M2M hijacking attack. The main difference of LTE compared to UMTS is that the RNC tasks have been absorbed by eNodeB. The latter is now assigned the task of reassembling the received data fragments towards reconstituting IP packets. GTP tunnels are similarly established here between eNodeB and SGW (SAE Gateway), as well as between SGW and PGW (PDN Gateway). Uplink IP packets are sent from eNobeB to SGW through the established GTP tunnel(s). The SGW strips the GTP header from each received uplink packet, includes a new GTP header, which corresponds to the GTP tunnel between SGW and PGW, and sends the packet to the latter. The PGW receives each packet, strips the GTP header that was imposed by SGW and further routes the packet to its final destination. The reverse operation takes place for packets destined to the end users. Authentication operations take place in a manner that is very similar to the case of UMTS and thus, the system is equally vulnerable to the hijacking attack, as in the case of UMTS.

In LTE, the hijacking attack may be mounted in the same manner as in UMTS. An adversary may either use a legitimate M2ME UICC, or obtain the IP address and the temporary identity of legitimate M2MEs through medium overhearing. In the former case, the adversarial device (equipped with the legitimate UICC) will successfully register with the access network, thereby freely using the offered network services. In the latter case, the attacker can embed the legitimate source IP address and temporary identifier into the uplink data packets destined to one or more intended recipients.

Embodiments of the invention for a LTE network Our solution can be applied in the same way as for the case of UMTS. The differences between the two cases are only related to the entities that apply the filtering operations. Specifically, in the case of LTE, eNodeB is expected to perform the filtering operations that were assigned to RNC for the case of UMTS. Similarly, SGW and PGW can perform filtering in the same way as SGSN and GGSN respectively.

Virtual network operators such as M2M operators who provide multiple application services to potentially more than one enterprise may also be vulnerable to attack. Recall that an M2M operator will generally have service level agreements with more than one access network provider. In addition, a given M2M operator may provide services to more than one vertical industry and in addition provide managed services by hosting application servers in a “cloud”. These managed services could be offered through a “private cloud” owned and operated by the M2MO or hosted in a public cloud by a cloud provider wherein the cloud provider and the M2MO have a business relationship. In these scenarios, an adversary could potentially reach a server in the cloud that provides “high value” application services through a “low value” M2M identity/subscription. Although the filtering techniques according to embodiments of the invention discussed so far will ensure that packets get forwarded only to the M2M operator's servers, they do not prevent an adversary from reaching web servers he is not supposed to in the M2MO's cloud.

FIG. 9 is an example illustration of the application of the attack to M2M operators who provide multiple application services to potentially more than one enterprise. An adversary may own an M2M device 1110, whose identity can be extracted. For example, the M2M device identity may reside on a UICC 1112. This identity including IP address is then spoofed by a laptop, smartphone etc. 11 owned by the adversary. Assume the M2M operator 1120 manages several application servers 1122 on behalf of many enterprises in a private or public cloud 1126. The adversary may then request services from a high value application server 1130 hosted in the same cloud. The application server may have independent user level authentication mechanisms, but these mechanisms are not tied to a specific subscription. Hence, the adversary may use a legitimate identity to access the server but charge the access to an M2M service.

In this example, the filtering mechanisms enforced in the access network will force the requests from the adversary to the M2M operator's cloud. But unless specific counter-measures within the cloud are in place, the adversary can reach an application server of his choice. This will result in the M2M operator billing the wrong application provider. In fact, this attack may go undetected.

Much like how IP layer and link layer filtering techniques have to be in place in the access network 1140, a corresponding set of IP layer, port, and application layer identities have to be in place within the cloud managed by the M2M operator. The details of such filtering mechanisms, and corresponding enablers, are straight forward extensions of methods discussed previously to thwart access network hijacks.

FIG. 12 depicts a high-level block diagram of a computer suitable for use in performing functions described herein for filtering M2M communications at a network node. As depicted in FIG. 12, computer 1200 includes a processor element 1202 (e.g., a central processing unit (CPU) and/or other suitable processor(s)) and a memory 1204 (e.g., random access memory (RAM), read only memory (ROM), and the like). The computer 1200 also may include a cooperating module/process 1205 and/or various input/output devices 1206 (e.g., a user input device (such as a keyboard, a keypad, a mouse, and the like), a user output device (such as a display, a speaker, and the like), an input port, an output port, a receiver, a transmitter, and storage devices (e.g., a tape drive, a floppy drive, a hard disk drive, a compact disk drive, and the like)).

It will be appreciated that the functions depicted and described herein may be implemented in software (e.g., via implementation of software on one or more processors) and/or hardware (e.g., using a general purpose computer, one or more application specific integrated circuits (ASIC), and/or any other hardware equivalents).

It will be appreciated that the functions depicted and described herein may be implemented in software for executing on a general purpose computer (e.g., via execution by one or more processors) so as to implement a special purpose computer, and/or may be implemented in hardware (e.g., using one or more application specific integrated circuits (ASIC) and/or one or more other hardware equivalents).

In one embodiment, the cooperating process 1205 can be loaded into memory 1204 and executed by processor 1202 to implement functions as discussed herein. Thus, cooperating process 1205 (including associated data structures) can be stored on a computer readable storage medium, e.g., RAM memory, magnetic or optical drive or diskette, and the like.

It will be appreciated that computer 1200 depicted in FIG. 12 provides a general architecture and functionality suitable for implementing functional elements described herein and/or portions of functional elements described herein. For example, the computer 1200 provides a general architecture and functionality suitable for implementing one or more of a M2ME, PDSN, RNC, AAA server, SGSN, GGSN, and other network nodes, and portions of these device and nodes and the like.

It is contemplated that some of the steps discussed herein as software methods may be implemented within hardware, for example, as circuitry that cooperates with the processor to perform various method steps. Portions of the functions/elements described herein may be implemented as a computer program product wherein computer instructions, when processed by a computer, adapt the operation of the computer such that the methods and/or techniques described herein are invoked or otherwise provided. Instructions for invoking the inventive methods may be stored in fixed or removable media, transmitted via a data stream in a broadcast or other signal bearing medium, and/or stored within a memory within a computing device operating according to the instructions.

Although various embodiments which incorporate the teachings of the present invention have been shown and described in detail herein, those skilled in the art can readily devise many other varied embodiments that still incorporate these teachings.

1. A method comprising:
receiving at a network node a packet destined for an intended destination;
determining by the network node whether the packet is associated with a machine-to-machine communication;
determining by the network node whether forwarding of the packet to the intended destination is prohibited, wherein forwarding of the packet is prohibited when the packet is originated from a first machine-to-machine device and is destined to a first host other than a machine-to-machine server associated with machine-to-machine communications; and
forwarding by the network node the packet to the intended destination when forwarding the packet is not prohibited.

2. The method of claim 1 wherein forwarding of the packet is further prohibited when the packet is originated from a second host other than a machine-to-machine server associated with machine-to-machine communications and is destined to a second machine-to-machine device.

3. The method of claim 1 wherein the determining whether the packet is associated with a machine-to-machine communication comprises:
querying a first memory based on a source address or a destination address of the packet.

4. The method of claim 3 wherein an entry of the first memory includes a first field identifying an address of a machine-to-machine device associated with an access network and a second field identifying an address of a M2M server that is associated with the machine-to-machine device.

5. The method of claim 4 wherein the entry of the first memory also includes fields identifying one or more of a Network Access Identifier (NAI) of the machine-to-machine device, a Generic Routing Encapsulation (GRE) key corresponding to the machine-to-machine device, a Tunnel End-point Identifier (TEID) corresponding to a General Packet Radio Service Tunneling Protocol (GTP) tunnel, a International Mobile Subscriber Identity (IMSI), and a machine-to-machine device permanent identifier.

6. The method of claim 3 further comprising:
receiving configuration messages including information for storing in the first memory.

7. The method of claim 1 wherein the network node is a Packet Data Serving Node (PDSN), a Radio Network Controller (RNC), a combination thereof such that the steps of the method are performed jointly by a PSDN and a RNC, a Mobile Networking Gateway, a layer 2 anchor point in a mobile Network, or a Messaging Gateway.

8. The method of claim 1 further comprising:
determining for the packet a mapping between GRE key and source IP address; and
wherein forwarding of the packet is further prohibited when the mapping for the packet is not verified.

9. An apparatus comprising a processor and an associated memory device, wherein the processor is configured to:
receive a packet destined for an intended destination;
determine whether the packet is associated with a machine-to-machine communication;
determine whether forwarding of the packet to the intended destination is prohibited, wherein forwarding of the packet is prohibited when the packet is originated from a first machine-to-machine device and is destined to a first host other than a machine-to-machine server associated with machine-to-machine communications; and
forward the packet to the intended destination when forwarding the packet is not prohibited.

10. The apparatus of claim 9 wherein the processor is configured is configured to prohibit forwarding of the packet when the packet is originated from a second host other than a machine-to-machine server associated with machine-to-machine communications and is destined to a second machine-to-machine device.

11. The apparatus of claim 9 wherein the processor is configured to perform a query of a first memory storage based on a source address or a destination address of the packet in order to determine whether the packet is associated with a machine-to-machine communication.

12. The apparatus of claim 11 wherein an entry of the first memory storage includes a first field identifying an address of a machine-to-machine device associated with an access network and a second field identifying an address of a M2M server that is associated with the machine-to-machine device.

13. The apparatus of claim 12 wherein the entry of the first memory storage further includes fields identifying one or more of a Network Access Identifier (NAI) of the machine-to-machine device, a Generic Routing Encapsulation (GRE) key corresponding to the machine-to-machine device, a Tunnel End-point Identifier (TEID) corresponding to a General Packet Radio Service Tunneling Protocol (GTP) tunnel, a International Mobile Subscriber Identity (IMSI), and a machine-to-machine device permanent identifier.

14. The apparatus of claim 11 wherein the associated memory comprises the first memory storage.

15. The apparatus of claim 11 wherein the first memory storage comprises a look-up table.

16. The apparatus of claim 11 wherein the processor is configured to receive configuration messages including information for storing in the first memory storage.

17. The apparatus of claim 9 wherein the apparatus is network node, a Packet Data Serving Node (PDSN), a Radio Network Controller (RNC), a combination thereof such that the steps of the method are performed jointly by a PSDN and a RNC, a Mobile Networking Gateway, a layer 2 anchor point in a mobile Network, or a Messaging Gateway.

18. The apparatus of claim 9 wherein the processor is configured to determine for the packet a mapping between GRE key and source IP address and to prohibit forwarding of the packet when the mapping for the packet is not verified.
